(19) United States
(12) Patent Application Publication
(10) Pub. No.: US 2020/0164717 A1
(43) Pub. Date: May 28, 2020

(54) PREDICTIVE CLIMATE SETTING SYSTEM FOR A VEHICLE HEATING VENTILATION AND AIR CONDITIONING SYSTEM

(71) Applicant: DENSO International America, Inc., Southfield, MI (US)

(72) Inventor: Reilly Patrick MULLETT, Livonia, MI (US)

(73) Assignee: DENSO International America, Inc., Southfield, MI (US)

(21) Appl. No.: 16/203,085

(22) Filed: Nov. 28, 2018

(51) Int. Cl. B60H 1/00

(52) U.S. Cl. CPC B60H 1/00735; B60H 1/00878; B60H 1/00985

(57) ABSTRACT

A predictive climate setting (PCS) system sets a temperature for an air-conditioning (AC) system in a subject vehicle. The PCS system includes a repository, an intelligent temperature calculator, and a temperature selector. The repository stores historical data indicative of temperature settings for various environmental conditions of the vehicle. The intelligent calculator calculates a predicted temp-setting based on the historical data stored in the repository, and on data indicative of current environmental conditions of the subject vehicle. The temperature selector sets a desired temperature setting selected from at least one of the predicted temp-setting and a user defined temp-setting inputted by a user of the subject vehicle. The temperature selector sets the predicted temp-setting as the desired temperature setting, absent the user defined temp-setting, to have the AC system of the subject vehicle control the cabin temperature based on the predicted temp-setting.

### FIELD

The present disclosure relates to controlling a vehicular heating, ventilation, and air-conditioning (HVAC) system, and more particularly, controlling the HVAC system based on one or more performance setpoints.

### BACKGROUND

The statements in this section merely provide background information related to the present disclosure and may not constitute prior art.

A vehicle typically includes a heating, ventilation, and air-conditioning (HVAC) system that controls the environmental condition within a passenger cabin of the vehicle in accordance with one or more performance setpoints manually defined by a user. More particularly, using a manually operable interface provided within the vehicle, the user is capable of controlling, for example, the temperature, the air-flow rate, and the air flow direction within the passenger cabin to his/her needs.

Without the user defined setpoints, the HVAC system is typically idle, and once the user's inputs are received, it can take the HVAC system some time to condition the air to the user's preferences; thus, leaving the passenger cabin uncomfortable. These and other issues are addressed by the teachings of the present disclosure.

### SUMMARY

This section provides a general summary of the disclosure, and is not a comprehensive disclosure of its full scope or all of its features.

The present disclosure is directed toward a predictive climate setting system for setting a temperature for an air-conditioning (AC) system in a subject vehicle. The predictive climate setting system includes a repository, an intelligent temperature calculator, and a temperature selector. The repository is configured to store historical data of a plurality of temperature settings in association with environmental data indicative of an environmental condition of the vehicle for a respective temperature setting. The intelligent temperature calculator is configured to calculate a predicted temp-setting based on the historical data stored in the repository, and on data indicative of current environmental conditions of the subject vehicle. The temperature selector is configured to set a desired temperature setting selected from at least one of the predicted temp-setting and a user defined temp-setting inputted by a user of the subject vehicle. The temperature selector sets the predicted temp-setting as the desired temperature setting absent the user defined temp-setting to have the AC system of the subject vehicle control the cabin temperature based on the predicted temp-setting.

In one form, the predictive climate setting system further includes a communication device configured to communicably couple to a plurality of vehicles. The subject vehicle is one of the plurality of vehicles.

In another form, the communication device acquires one or more temperature settings and environmental data from the plurality of vehicles. The repository stores the one or more temperature settings and associated environmental data from the vehicles as part of the historical data.

In yet another form, the environmental condition of the vehicle includes at least one of a cabin temperature, an outside ambient temperature, a sun-load temperature, and a humidity level.

In one form, the temperature selector sets the user defined temp-setting as the desired temperature setting in response to the user defined temp-setting being inputted by the user.

In another form, the repository stores at least one of the desired temperature setting, the predicted temp-setting, and the data indicative of current environmental conditions of the subject vehicle as part of the historical data.

In yet another form, the present disclosure is directed toward a system including a predictive climate setting system and an air-conditioning system. The air-conditioning system is operable to control a cabin temperature of a passenger cabin of the subject vehicle, and communicably coupled to the predictive climate setting system.

In one form, the predictive climate setting system and the air-conditioning system are disposed at the subject vehicle.

In another form, the predictive climate setting system is disposed external of the subject vehicle, and the air-conditioning system is disposed at the subject vehicle.

In one form, the present disclosure is directed toward a predictive climate setting system for an air-conditioning (AC) system in a subject vehicle. The predictive climate setting system includes a communication device, a repository, a temperature request module, an intelligent temperature calculator, and a temperature selector. The communication device is configured to communicably couple to one or more vehicles. The subject vehicle is one of the vehicles. The repository is configured to store a plurality of AC control records for one or more of the plurality of vehicles. A given AC control record for a given vehicle includes at least one of a temperature setting, environmental data indicative of an environmental condition of the given vehicle for a respective temperature setting, and a user identification information. The temperature request module is configured to receive a temperature setting request for the subject vehicle. The temperature setting request includes at least one of data indicative of current environmental conditions of the subject vehicle, and data identifying a requesting user. The intelligent temperature calculator is configured to calculate a predicted temp-setting based on one or more of the AC control records stored in the repository and on the temperature setting request. The one or more AC control records are associated with at least one of the requesting user and the current environmental conditions of the subject vehicle. The temperature selector is configured to set a desired temperature setting selected from at least one of the predicted temp-setting and a user defined temp-setting. Absent the user defined temp-setting, the temperature selector sets the predicted temp-setting from the intelligent temperature calculator as the desired temperature setting and outputs the predicted temp-setting to the AC system of the subject vehicle.

In another form, the repository is configured to store a new AC record that includes at least one of the desired temperature setting, the predicted temp-setting, the current environmental conditions of the subject vehicle, and the user identification information for the temperature setting request.

In yet another form, the temperature request module acquires at least one of a user specific record and a condition specific record from the repository, as the one or more AC control records used by the intelligent temperature calculator. The user specific record is associated with the requesting user, and the condition specific record defines environmental conditions that correlate with the current environmental conditions of the subject vehicle.

In one form, the intelligent temperature calculator calculates a customized temperature setting, as the predicted temp-setting, based on the user specific records or a general temperature setting, as the predicted temp-setting, based on the condition specific records.

In another from, the environmental condition of the vehicle includes at least one of a cabin temperature, an outside ambient temperature, a sun-load temperature, and a humidity level.

In yet another form, the temperature selector sets the user defined temp-setting, as the desired temperature setting, in response to the user defined temp-setting being inputted by the user.

In one form, the communication device is configured to communicably couple to one or more portable computing devices for receiving the temperature setting request for the subject vehicle.

In one form, the present disclosure is directed toward a predictive climate setting system for an air-conditioning (AC) system in a subject vehicle. The predictive climate setting system includes a communication device, an AC record module, a temperature request module, an intelligent temperature calculator, and a temperature selector. The communication device is configured to communicably couple to one or more vehicles, one or more portable computing devices, or a combination thereof. The subject vehicle is one of the vehicles, and the communication device is configured to receive AC information from the vehicles and a temperature setting request for the subject vehicle. The AC record module is configured to generate and store a plurality of AC control records in a repository based on the AC information received. A given AC control record includes at least one of a temperature setting for a given vehicle, environmental data indicative of an environmental condition of the given vehicle for a respective temperature setting, and a user identification information for a user of the given vehicle. The temperature request module is configured to acquire one or more AC control records from the repository based on the temperature setting request. The temperature setting request includes at least one of data indicative of current environmental conditions of the subject vehicle, and data identifying a requesting user. The intelligent temperature calculator is configured to calculate a predicted temp-setting based on the one or more of the AC control records and the current environmental conditions of the subject vehicle. The temperature selector is configured to set a desired temperature setting selected from at least one of the predicted temp-setting and a user defined temp-setting. Absent the user defined temp-setting, the temperature selector sets the predicted temp-setting from the intelligent temperature calculator as the desired temperature setting, and the temperature selector outputs the predicted temp-setting to the AC system of the subject vehicle via the communication device.

In another form, the temperature request module acquires at least one of a user specific record and a condition specific record from the repository, as the one or more AC control records. The user specific record is associated with the requesting user, and the condition specific record defines environmental conditions that correlate with the current environmental conditions of the subject vehicle.

In yet another form, the intelligent temperature calculator calculates a customized temperature setting, as the predicted temp-setting, based on one or more of the user specific records or a general temperature setting, as the predicted temp-setting, based on one or more of the condition specific records.

In one form, the temperature selector sets the user defined temp-setting, as the desired temperature setting, in response to the user defined temp-setting being inputted by the user.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a predictive climate setting (PCS) system in accordance with the teachings of the present disclosure in communication with multiple vehicles and devices;

FIG. 2 is a partial cross-sectional view of a subject vehicle;

FIG. 3 is a block diagram of a heating, ventilation, and air-conditioning system of the subject vehicle in accordance with the teachings of the present disclosure;

FIG. 4 is a block diagram of the PCS system in accordance with the present disclosure;

FIG. 5 is a flowchart of an example temperature setting request routine in accordance with the present disclosure; and

FIGS. 6A and 6B are flowcharts of a predictive climate control routine system in accordance with the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

A predictive climate setting (PCS) system of the present disclosure is configured to define performance setpoint(s) for a vehicular heating, ventilation, air-conditioning (HVAC) system. Specifically, the PCS system predicts a desired temperature setting for a passenger cabin of a vehicle (i.e., a cabin temperature). As described further herein, the PCS system acquires and stores, from one or more vehicles, data indicative of temperature settings for an HVAC system and environmental data indicative of the environmental condition of the vehicle at the time of the respective temperature setting. In one form, the temperature setting is a performance setpoint used by the HVAC system to control the cabin temperature. Based on the stored data and predefined statistical algorithms, the PCS system predicts a temperature setting (i.e., a predicted temperature setting or predicted temp-setting) for a subject vehicle, which in return automatically regulates the environment within the passenger cabin based on the temperature setting.

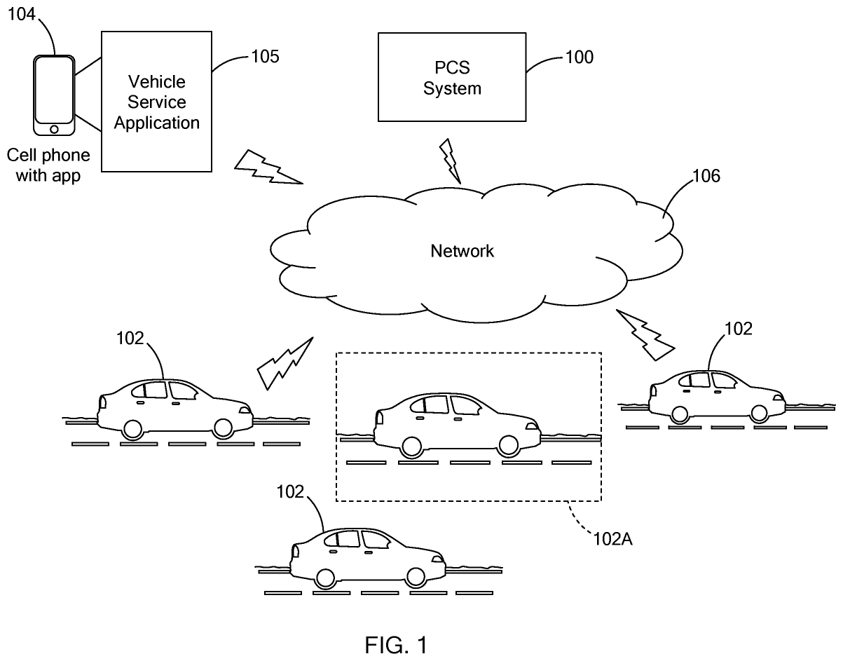

Referring to FIG. 1, a predictive climate setting (PCS) system 100 is configured to communicably couple to one or more vehicles 102 and/or to non-vehicular devices, such as a smartphone 104, by way of a wireless communication network 106. In one form, the vehicles 102 are configured to perform vehicle-to-vehicle communication (i.e., V2V) and/or vehicle-to-everything (i.e., V2X) communication via the wireless communication network 106 supported by short-range communications devices operable in, for example, the 5.9 GHz band (e.g., Wi-Fi). Other suitable devices and/or protocols may be used for establishing the wireless communication network 106 while remaining in scope of the present disclosure.

In one application, the vehicles 102 may be fully-autonomous vehicles, semi-autonomous vehicles, manually operated vehicles, or a combination thereof. For example, one or more of the vehicles 102 may be part of a fleet of autonomous vehicles managed by a service company and accessible by one or more users. In another application, in addition to or in lieu of the fleet, one or more of the vehicles 102 are privately owned by a user.

In one form, a user is capable of accessing and controlling a subject vehicle 102A by way of a vehicle service application 105 stored and executed by a portable computing device, such as the smartphone 104. As known in the art, a portable computing device includes a microprocessor, a memory storing computer readable instructions executable by the microprocessor, a user input-output interface (e.g., touch screen, I/O ports, etc.), a communication interface (e.g., transceiver) for establishing one or more wireless communication links, such as but not limited to: BLUETOOTH, WI-FI, cellular networks, etc. The vehicle service application 105 is provided as a computer software program that is supported and executed by the portable computing device. In one form, the vehicle service application 105 is operable by the user via one or more graphical user interfaces to issue a remote command to the subject vehicle 102A. For example, the vehicle service application 105 is operable to summon the subject vehicle 102A if the vehicle is autonomous/semi-autonomous vehicle, and/or turn-on the subject vehicle 102A via a remote start feature. The vehicle service application 105 is configured to store user identification information for identifying the user operating the vehicle service application 105, such as a name of the user, a unique alpha-numeric string associated with the user, and/or other suitable identification method. Based on the user's selection, the vehicle service application 105 transmits one or more remote commands to the subject vehicle 102A with the user identification information.

In addition to the requested remote command, the vehicle service application 105 is configured to transmit one or more supplementary commands such as defining a temperature setting. For example, when the user summons the subject vehicle 102A or performs a remote start, the vehicle service application 105 transmits a temperature setting request to the subject vehicle 102A and/or to the PCS system 100 to operate the HVAC system and, thus, control the cabin temperature of the subject vehicle 102A.

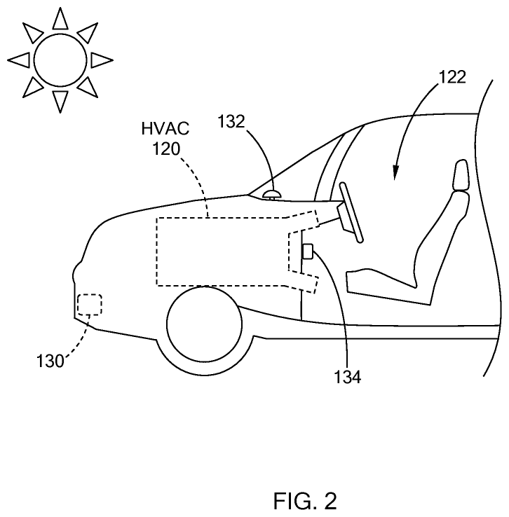

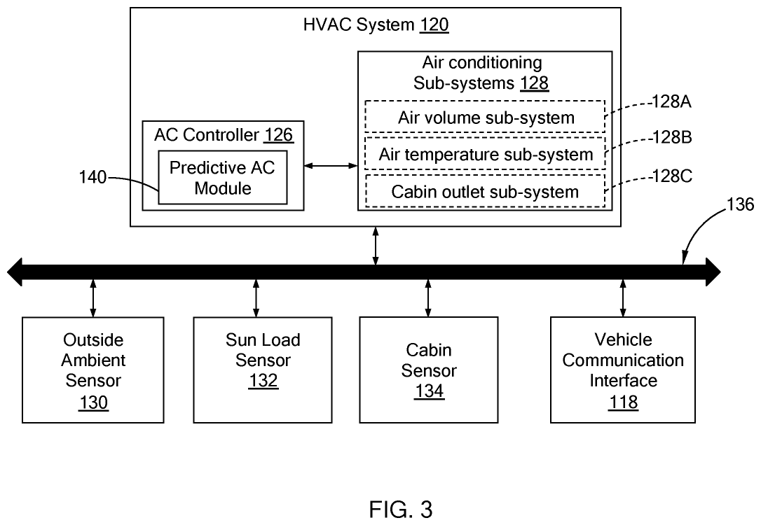

Referring to FIGS. 2 and 3, the subject vehicle 102A generally includes a vehicle communication interface 118 and an HVAC system 120 to control the environmental condition within the passenger cabin 122. In one form, the vehicle communication interface 118 is configured to communicably couple external systems/devices with controllers disposed within the subject vehicle 102A. The vehicle communication interface 118 may include hardware components, such as a transceiver, and a controller, and software for performing various operations. More particularly, in one form, the vehicle communication interface 118 is configured to process data received and forward it to respective controllers within the subject vehicle 102A. For example, the vehicle communication interface 118 transmits a remote start command or a summons command to a main controller (not shown) in control of turning on the vehicle. In another example, the vehicle communication interface 118 transmits the temperature setting request to the HVAC system 120. In addition, the vehicle communication interface 118 is configured to transmit data, such as temperature setting request and historical data, from controllers within the subject vehicle 102A to the PCS system 100 and/or vehicle service application 105.

The HVAC system 120 includes various components such as: an air blower to control the flow of air in the cabin; one or more heat exchangers, such as an evaporator and heater core; compressor; condenser; thermal expansion value; accumulator; a housing that defines passages for receiving and mixing air; one or more motorized doors to control the flow of air through the passages; and outlet ports for discharging conditioned air to the passenger cabin. It should be readily understood that specific components of a given HVAC system 120 in one vehicle 102 may be different from the specific components of the HVAC system 120 of another vehicle 102 while remaining within the scope of the present disclosure. For brevity, the HVAC system may also be referred to as an air-conditioning (AC) system.

The AC system 120 further includes an air-conditioning (AC) controller 126 to control one or more AC sub-systems 128 that include, but are not limited to: an air volume sub-system 128A, an air temperature sub-system 128B, and a cabin outlet sub-system 128C. The air volume sub-system 128A controls the amount of outside air entering the HVAC system 120 by way of the air blower. The air temperature sub-system 128B conditions the outside air to a desired temperature (e.g., air outlet temperature, TAO) by way of the heat exchangers, compressor, condenser, thermal expansion value, accumulator, and the air passages. The cabin outlet sub-system 128C directs the conditioned air to the appropriate outlet extending in the passenger cabin by operating one or more motorized doors within the housing.

The AC controller 126 is configured to determine one or more operational setpoints of the AC sub-systems 128 based on environmental conditions of the vehicle 102A, one or more user defined inputs, and/or the temperature setting recommended by the PCS system 100. Examples of such operational setpoints include, but are not limited to: an air outlet temperature, an air-blower speed, a motorized door position, etc. In one form, the environmental conditions include a cabin temperature, an outside ambient temperature, and a sun-load temperature, which are measured by various sensors disposed about the subject vehicle 102A. For example, the subject vehicle 102A includes an outside ambient sensor 130 to measure the outside ambient temperature (T_{OUT}), a sun-load sensor 132 to measure sun-load temperature (T_{SL}), and a cabin sensor 134 to measure the cabin temperature (T_{C}). The outside ambient temperature, the sun-load temperature, and the cabin temperature are examples of environmental data. Other environmental conditions may also be used, such as a humidity level and, thus, should not be limited to the examples provided herein.

In one form, the AC controller 126 is communicably coupled to various sensors, such as sensors 130, 132, and 134, and other controllers in the subject vehicle 102A, via a vehicular network 136 such as controller access network (CAN), a local interconnect network (LIN), or other suitable communication network. It should be readily understood that the AC controller 126 may retrieve data from other sensors and/or controllers within the vehicle 102 to determine the operational setpoints. For example, the AC controller 126 may acquire an evaporator temperature, a heater core water temperature, a blower speed, an engine operation status (i.e., engine ON or Off), and an engine temperature to determine the operational setpoints for controlling the AC system 120.

In one form, the user defines a temperature setting by way of a climate control panel (not shown) that is disposed within the passenger cabin 122 and includes one or more user interfaces, such as buttons, rotatable knobs, and/or touchscreen monitor. The user interfaces of the climate control panel may be directly coupled to the AC controller 126 to provide the user defined inputs or may transmit the inputs via the vehicular network 136. In lieu of or in addition to using the climate control panel, the user may set the performance setpoint via the vehicle service application 105. For example, the vehicle service application 105 is configured to display a climate control interface that is operable by the user to set the temperature setting of the vehicle 102A. Once entered, the temperature setting is transmitted to the AC controller 126 via the wireless network 106. In the following, the temperature setting defined by the user is referred to as a user defined temp-setting.

Using predefined control algorithms, the AC controller 126 determines the operational setpoints of the HVAC system 120, such as an ambient air outlet temperature (T_{AO}) and/or blower speed, for meeting one or more of the performance setpoints. For example, in one form, the AC controller 126 calculates the ambient outlet temperature using Equation 1 below in which T_{SET} is the desired temperature setting, K_{SET} is a coefficient related to the temperature setting, T_{C} is the cabin temperature, K_{C} is a coefficient related to the cabin temperature, T_{OUT} is the outside ambient temperature, K_{OUT} is a coefficient related to the outside ambient temperature, T_{SL} is the sun-load temperature, K_{SL} is a coefficient related to the sun-load temperature, and C is a predefined constant. Based on the ambient outlet temperature, the AC controller 126 operates the AC sub-systems 128 such that the air exiting an outlet of the HVAC system 120 to the passenger cabin 122 is substantially equal to the calculated ambient outlet temperature. The AC controller 126 may continuously reevaluate the ambient air outlet temperature to adjust the operation of the HVAC system 120 until the environment within the passenger cabin meets the performance setpoints.

T_{AO}=(T_{SET}*K_{SET})−(T_{C}*K_{C})−(T_{OUT}*K_{OUT})−(T_{SL}*K_{SL})+C Equation 1

Equation 1 is just one method of calculating the ambient air outlet temperature. Other equations may be used and are within the scope of the present disclosure. In addition, the ambient air outlet temperature is just one example of an operational setpoint of the HVAC system 120. Other suitable setpoints may be used and are within the scope of the present disclosure.

With continuing reference to FIG. 3, the AC controller 126 further includes a predictive AC module 140 that is configured to provide data to the PCS system 100 and request a predicted temperature setting. More particularly, the predictive AC module 140 is configured to provide to the PCS system 100 the user defined temperature setting(s) and environmental data indicative of the environmental condition of the subject vehicle 102A at the time the respective temperature setting is set.

Furthermore, the predictive AC module 140 may be configured to provide a temperature setting request to the PCS system 100. For example, the predictive AC module 140 may transmit the temperature setting request to the PCS system 100 in response to receiving the summons or the remote start command from the vehicle service application 105 and/or once the subject vehicle 102A is turned on. In one form, the temperature setting request includes data indicative of at least one of current environmental conditions of the subject vehicle 102A, the user identification information of the user, and/or vehicle identification of the subject vehicle 102A requesting the temperature setting. The predictive AC module 140 may obtain the user identification information from the vehicle service application 105 when the vehicle service application 105 transmits a temperature setting request to the subject vehicle 102A, and a vehicle identification information, such as a unique alpha-numeric string associated with the vehicle, from the main controller (not shown). While the predictive AC module 140 is provided as being part of the AC controller 126, the predictive AC module 140 may be implemented as a separate controller from the AC controller 126 and communicates with the AC controller 126 via the vehicular network 136.

While the predictive AC module 140 is described as requesting the temperature setting, in another application, the temperature setting request may be transmitted to the PCS system 100 by the vehicle service application 105. For example, if the user summons the subject vehicle 102A via the application 105, the application 105 acquires the current environmental conditions of the subject vehicle 102A from the AC controller 126 of the subject vehicle 102A, and transmits a temperature setting request to the PCS system 100.

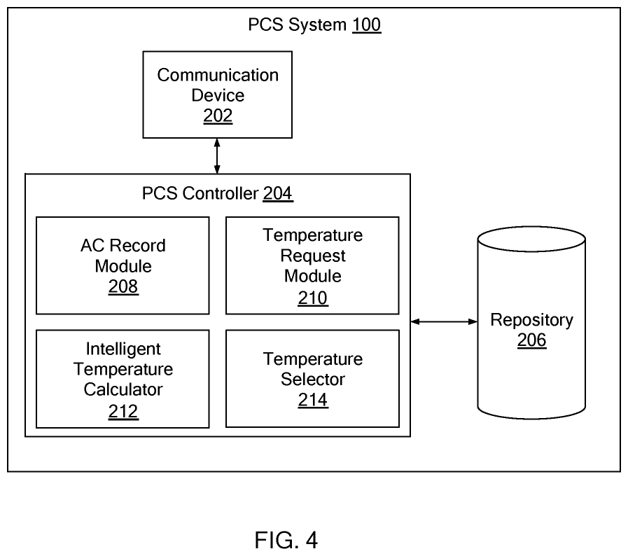

The PCS system 100 determines the predicted temperature setting for the subject vehicle 102A based on information in the temperature setting request and predefined algorithms. in one form, the PCS system 100 is provided as a server system disposed remotely from the vehicles 102. Referring to FIG. 4, the PCS system 100 includes a communication device 202, a PCS controller 204, and a repository 206. The communication device 202 is configured to communicate with the vehicles 102 and/or devices via the wireless communication network 106, and includes hardware, such as a transceiver and a microprocessor, and software executed by the microprocessor for performing various operations, such as exchanging data via predetermined protocols. The repository 206 may be provided as one or more memory devices, a database, a datastore, or other suitable structure for storing data.

The PCS controller 204 is configured to exchange data with the vehicles 102 via the communication device 202 and to generate a predicted temp-setting for a requesting subject vehicle 102A. The PCS controller 204 may include a combination of electronics (e.g., microprocessor, memory, a I/O interface, etc.) and software programs/algorithms stored in memory and executable by the microprocessor to perform the operations described herein. In one form, the PCS controller 204 includes an AC record module 208, a temperature request module 210, an intelligent temperature calculator 212, and a temperature selector 214.

In one form, the AC record module 208 stores temperature settings and environmental data received from the vehicles 102 in the repository 206, as historical data used for predicting a temperature setting. Specifically, the AC record module 208 is configured to receive AC information from the vehicle(s) 102 via the communication device 202, and stores the AC information as an AC control record in the repository 206. The AC information includes at least one of, but is not limited to: the vehicle identification information; user identification information for identifying the user associated with the temperature setting; the temperature setting used by the HVAC system for controlling the environmental condition within the passenger cabin; information indicating whether the temperature setting was a recommended setting from the PCS system 100 or defined by the user; and/or environmental data indicative of the environmental condition of the subject vehicle 102A for the respective temperature setting, such as outside ambient temperature, the sun-load temperature, and humidity level. It should be understood that other information may also be provided with the AC information while remaining within the scope of the present disclosure.

The temperature request module 210 is configured to acquire n one or more of the AC control records from the repository 206 based on the information in the temperature setting request. More particularly, in one form, the temperature request module 210 obtains AC control records that are associated with the requesting user and/or that have environmental conditions that correlate to (e.g., substantially the same) to those provided in the request. For example, if the user identification information provided in a given AC control record identifies the requesting user in the temperature setting request, such records is provided as a user specific record. From among the user specific records, the temperature request module 210 may select AC control records that define environmental conditions that correlate to those provided in the request. In addition to or in lieu of the user specific records, the temperature request module 210 is configured to select AC control records that define environmental conditions that correlate with the current environmental conditions of the subject vehicle, but are not associated with the user. These types of AC control records are provided as condition specific records. Accordingly, if the repository 206 does not store AC control records specific to the requesting user, the PCS controller 204 may still estimate the temperature setting based on historical data from other users.

The intelligent temperature calculator 212 is configured to calculate a predicted temperature setting based on the historical data stored in the repository 206, and on data indicative of current environmental conditions of the subject vehicle 102A. More particularly, the intelligent temperature calculator 212 uses the one or more AC control records selected by the temperature request module 210 and predefined statistical algorithms to determine a predicted temperature setting. For example, in one form, the intelligent temperature calculator 212 is configured to determine a historical trend that correlates environmental conditions with the temperature settings to estimate the predicted temperature setting for the current environmental conditions. Various statistical algorithms may be used to estimate the predicted temperature setting.

In one form, if at least one of the selected AC control records is a user specific record, the intelligent temperature calculator 212 calculates a customized temperature setting, as the predicted temperature setting. Conversely, if none of the selected AC control records is a user specific record, the intelligent temperature calculator 212 calculates a general temperature setting, as the predicted temperature setting, based on the selected AC control records that are not associated with the requesting user.

The temperature selector 214 is configured to set a desired temperature setting selected from at least one of the predicted temperature setting and the user defined temp-setting to the HVAC system 120 of the subject vehicle 102A. Specifically, if the user defined temperature setting is not provided, the temperature selector 214 sets the predicted temperature setting from the intelligent temperature calculator 212 as the desired temperature setting and provides the predicted temperature setting to the subject vehicle 102A. On the other hand, if the user defined temp setting is provided, the temperature selector sets the user defined temp-setting as the desired temperature setting. The user may define the temperature setting at any time during the use of the subject vehicle 102A.

In one form, the AC record module generates an AC control record for recording at least one of the temperature setting request, the predicted temperature setting, and the desired temperature setting selected for the request. Accordingly, in the event a user defined temp-setting and a predicted temperature setting are provided, the AC record module 208 stores both temperature settings in the AC control record, which are used in future analysis for learning the setting preferences of the user.

While the PCS system 100 is provided as an external server system, the PCS system 100 may also be disposed within the subject vehicle 102A to provide predicted temperature setting only for the subject vehicle 102A or for a selected group of vehicles 102. In such application, the communication device of the PCS system 100 can be provided as the vehicle communication interface 118.

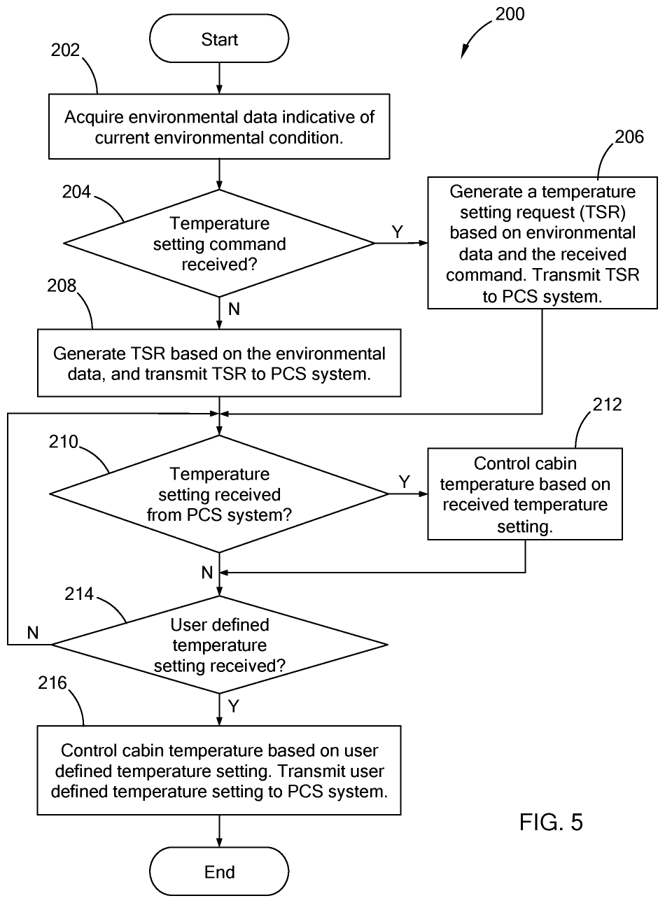

Referring to FIG. 5, an example flowchart of a temperature setting request routine 200 performed by an AC controller of a subject vehicle is provided. This routine may be performed once the subject vehicle is turned on and power is being supplied to the AC controller. At 202, the AC controller assesses the environmental condition of the subject vehicle by acquiring environmental data from one or more sensors disposed about the subject vehicle. At 204, the controller determines whether a temperature setting command is received from, for example, the vehicle service application. If so, the AC controller, at 206, generates and transmits a temperature setting request that includes data indicative of the environmental condition and/or information in the received command (e.g., user identification information) to the PCS system. If not, the AC controller, at 208, generates and transmits a temperature setting request based on the environmental data and, thus, may not include user identification information.

At 210, the AC controller determines whether the temperature setting is received from the PCS system. If so, the AC controller controls the cabin temperature based on the received temperature setting, at 212. At 214, whether a temperature setting is received or not from the PCS system, the AC controller determines whether the user has defined a temperature setting. That is, even if a predicted temperature setting is provided, the user may still define the temperature setting for controlling the HVAC system. If the user has not defined a temperature setting, the AC controller returns to 210. If the user has defined a temperature setting, the AC controller controls the cabin temperature based on the user defined temperature setting and transmits the user defined temperature setting to the PCS system, at 216. It should be readily understood that temperature setting request routine is just one example of requesting a temperature setting from the PCS system, and that other methods may be used and are within scope of the present disclosure.

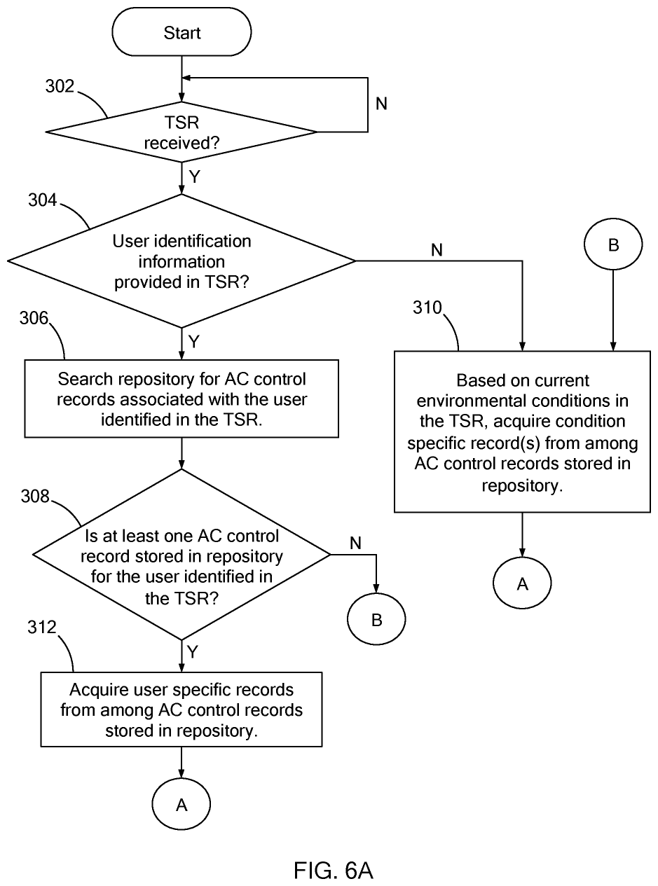

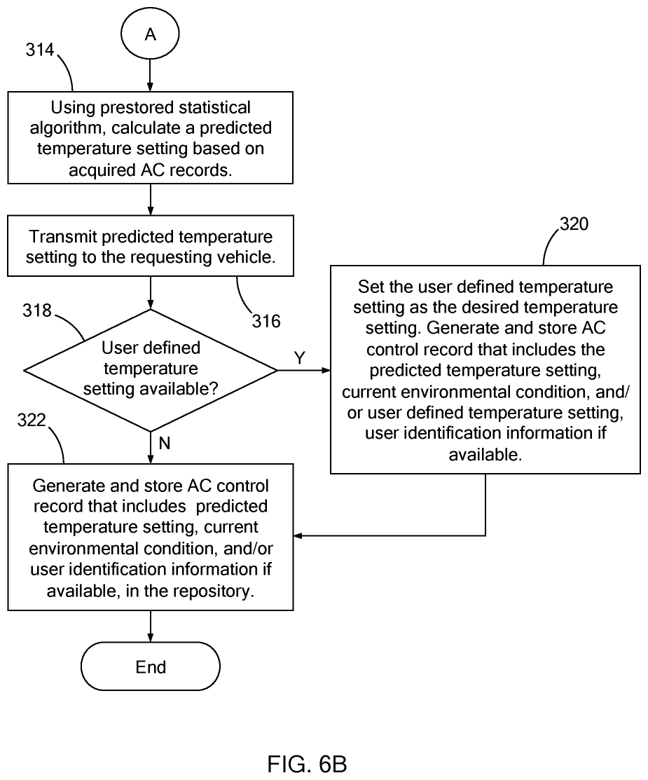

Referring to FIGS. 6A and 6B, an example predictive climate control routine 300 performed by the PCS system of the present disclosure is provided. At 302, the PCS system determines whether a temperature setting request is received. If so, the PCS system determines whether the request includes user identification information, at 304. If so, the PCS system searches the repository for AC control records associated with the user, at 306, and determines if at least one AC control record is stored for the user, at 308. If the temperature setting request does not include user information or if there are no AC control records associated with the user, the PCS system, at 310, acquires condition specific records from among the AC control records based on the environmental conditions provided in the temperature setting request. If at least one AC control record is provided in the repository for the user, the PCS system at 312 acquires the user specific records from among the AC control records.

From 312 and 310, the PCS system, at 314, calculates a predicted temperature setting based on the acquired AC records and prestored statistical algorithms. At 316, the PCS system transmits the predicted temperature setting to the subject vehicle. At 318, the PCS system determines if a user defined temperature setting is available. If so, at 320, the user defined temperature setting is set as the desired temperature setting, and the PCS system generates a stores an AC control record that includes the predicted temperature setting, current environmental condition, user defined temperature setting, and user identification information if available. If there is no user defined temperature setting, the predicted temperature setting is set as the desired temperature setting, and the PCS system at 322, generates and stores an AC control record that includes the predicted temperature setting, current environmental condition, and user identification information if available. It should be readily understood that the predictive climate control routine 300 is just one example control routine of the PCS system, and that other control routines may be implemented and are within scope of the present disclosure.

The PCS system of the present disclosure is configured to estimate performance setpoints for an HVAC system using historical data and predefined algorithm. The predicted setpoints, such as a temperature setting, allows the HVAC system to begin conditioning air provided to the passenger cabin of the vehicle automatically, without relying a user's input. Furthermore, the PCS system is configured to record a user defined temperature setting that may adjust the predicted temperature setting, and thus, allow the PCS system to learn the user's preferences for future predictions.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, manufacturing technology, and testing capability.

The description of the disclosure is merely exemplary in nature and, thus, variations that do not depart from the substance of the disclosure are intended to be within the scope of the disclosure. Such variations are not to be regarded as a departure from the spirit and scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

As used herein, the phrase at least one of A, B, and C should be construed to mean a logical (A OR B OR C), using a non-exclusive logical OR, and should not be construed to mean “at least one of A, at least one of B, and at least one of C.” It should be understood that one or more steps within a method may be executed in different order (or concurrently) without altering the principles of the present disclosure.

What is claimed is:

1. A predictive climate setting system for setting a temperature for an air-conditioning (AC) system in a subject vehicle, the predictive climate setting system comprising:
a repository configured to store historical data of a plurality of temperature settings in association with environmental data indicative of an environmental condition of the vehicle for a respective temperature setting;
an intelligent temperature calculator configured to calculate a predicted temp-setting based on the historical data stored in the repository, and on data indicative of current environmental conditions of the subject vehicle; and
a temperature selector configured to set a desired temperature setting selected from at least one of the predicted temp-setting and a user defined temp-setting inputted by a user of the subject vehicle, wherein the temperature selector sets the predicted temp-setting as the desired temperature setting absent the user defined temp-setting to have the AC system of the subject vehicle control the cabin temperature based on the predicted temp-setting.

2. The predictive climate setting system of claim 1 further comprising a communication device communicably coupled to a plurality of vehicles, wherein the subject vehicle is one of the plurality of vehicles.

3. The predictive climate setting system of claim 2, wherein:
the communication device acquires one or more temperature settings and environmental data from the plurality of vehicles, and
the repository stores the one or more temperatures settings and associated environmental data from the vehicles as part of the historical data.

4. The predictive climate setting system of claim 1, wherein the environmental condition of the vehicle includes at least one of a cabin temperature, an outside ambient temperature, a sun-load temperature, and a humidity level.

5. The predictive climate setting system of claim 1, wherein the temperature selector sets the user defined temp-setting as the desired temperature setting in response to the user defined temp-setting being inputted by the user.

6. The predictive climate setting system of claim 1, wherein the repository stores at least one of the desired temperature setting, the predicted temp-setting, and the data indicative of current environmental conditions of the subject vehicle as part of the historical data.

7. A system comprising:
the predictive climate setting system of claim 1; and
an air-conditioning system operable to control a cabin temperature of a passenger cabin of the subject vehicle, and communicably coupled to the predictive climate setting system.

8. The system of claim 7, wherein the predictive climate setting system and the air-conditioning system are disposed at the subject vehicle.

9. The system of claim 7, wherein the predictive climate setting system is disposed external of the subject vehicle, and the air-conditioning system is disposed at the subject vehicle.

10. A predictive climate setting system for an air-conditioning (AC) system in a subject vehicle, the predictive climate setting system comprising:
a communication device configured to communicably couple to one or more vehicles, wherein the subject vehicle is one of the vehicles;
a repository configured to store a plurality of AC control records for one or more of the plurality of vehicles, wherein a given AC control record for a given vehicle includes at least one of a temperature setting, environmental data indicative of an environmental condition of the given vehicle for a respective temperature setting, and an user identification information;
a temperature request module configured to receive a temperature setting request for the subject vehicle, wherein the temperature setting request includes at least one of data indicative of current environmental conditions of the subject vehicle, and data identifying a requesting user;
an intelligent temperature calculator configured to calculate a predicted temp-setting based on one or more of the AC control records stored in the repository and on the temperature setting request, wherein the one or more AC control records are associated with at least one of the requesting user and the current environmental conditions of the subject vehicle; and
a temperature selector configured to set a desired temperature setting selected from at least one of the predicted temp-setting and a user defined temp-setting, wherein absent the user defined temp-setting, the temperature selector sets the predicted temp-setting from the intelligent temperature calculator as the desired temperature setting and outputs the predicted temp-setting to the AC system of the subject vehicle.

11. The predictive climate setting system of claim 10, wherein the repository is configured to store a new AC record that includes at least one of the desired temperature setting, the predicted temp-setting, the current environmental conditions of the subject vehicle, and the user identification information for the temperature setting request.

12. The predictive climate setting system of claim 10, wherein the temperature request module acquires at least one of a user specific record and a condition specific record from the repository, as the one or more AC control records used by the intelligent temperature calculator, further wherein the user specific record is associated with the requesting user, and the condition specific record defines environmental conditions that correlate with the current environmental conditions of the subject vehicle.

13. The predictive climate setting system of claim 12, wherein the intelligent temperature calculator calculates a customized temperature setting, as the predicted temp-setting, based on the user specific records or a general temperature setting, as the predicted temp-setting, based on the condition specific records.

14. The predictive climate setting system of claim 10, wherein the environmental condition of the vehicle includes at least one of a cabin temperature, an outside ambient temperature, a sun-load temperature, and a humidity level.

15. The predictive climate setting system of claim 10, wherein the temperature selector sets the user defined temp-setting, as the desired temperature setting, in response to the user defined temp-setting being inputted by the user.

16. The predictive climate setting system of claim 10, wherein the communication device is communicably coupled to one or more portable computing devices for receiving the temperature setting request for the subject vehicle.

17. A predictive climate setting system for an air-conditioning (AC) system in a subject vehicle, the predictive climate setting system comprising:
a communication device configured to communicably couple to one or more vehicles, one or more portable computing device, or a combination thereof, wherein the subject vehicle is one of the vehicles, and the communication device is configured to receive AC information from the vehicles and a temperature setting request for the
an AC record module configured to generate and store a plurality of AC control records in a repository based on the AC information received, wherein a given AC control record includes at least one of a temperature setting for a given vehicle, environmental data indicative of an environmental condition of the given vehicle for a respective temperature setting, and a user identification information for a user of the given vehicle;
a temperature request module configured to acquire one or more AC control records from the repository based on the temperature setting request, wherein the temperature setting request includes at least one of data indicative of current environmental conditions of the subject vehicle, and data identifying a requesting user;
an intelligent temperature calculator configured to calculate a predicted temp-setting based on the one or more of the AC control records and the current environmental conditions of the subject vehicle; and
a temperature selector configured to set a desired temperature setting selected from at least one of the predicted temp-setting and a user defined temp-setting, wherein absent the user defined temp-setting, the temperature selector sets the predicted temp-setting from the intelligent temperature calculator as the desired temperature setting, and the temperature selector outputs the predicted temp-setting to the AC system of the subject vehicle via the communication device.

18. The predictive climate setting system of claim 17, wherein the temperature request module acquires at least one of a user specific record and a condition specific record from the repository, as the one or more AC control records, wherein the user specific record is associated with the requesting user, and the condition specific record defines environmental conditions that correlate with the current environmental conditions of the subject vehicle.

19. The predictive climate setting system of claim 18, wherein the intelligent temperature calculator calculates a customized temperature setting, as the predicted temp-setting, based on one or more of the user specific records or a general temperature setting, as the predicted temp-setting, based on one or more of the condition specific records.

20. The predictive climate setting system of claim 17, wherein the temperature selector sets the user defined temp-setting, as the desired temperature setting, in response to the user defined temp-setting being inputted by the user.
